(19) United States
(12) Patent Application Publication
(10) Pub. No.: US 2022/0012837 A1
(43) Pub. Date: Jan. 13, 2022

(54) SYSTEM AND METHOD FOR DETERMINING INTERESTS IN THE OUTCOME OF AN EVENT

(71) Applicant: Jackson Hunter REINHART, Richmond, VA (US)

(72) Inventor: Jackson Hunter REINHART, Richmond, VA (US)

(21) Appl. No.: 17/369,530

(22) Filed: Jul. 7, 2021

Related U.S. Application Data
(60) Provisional application No. 62/705,618, filed on Jul. 8, 2020.

(51) Int. Cl. G06Q 50/34; G06Q 40/04; G07F 17/32

(52) U.S. Cl. CPC G06Q 50/34; G07F 17/3288; G06Q 40/04

(57) ABSTRACT

A system and method of valuing interests in outcome determinative events including creating units based on the predicted outcome of the event and enabling trading of the units prior to commencement of the event.

This application claims priority to U.S. Provisional Pat. App. Ser. No. 62/705,618 filed Jul. 8, 2020.

### BACKGROUND

The present application is directed to determining interests in the outcome of an event, and in one embodiment, an organized wagering system and method. More specifically, it is directed to a wagering system and method that determines initial pricing of a wager and provides a secondary market, which determines the current value of the wager based on real-life events.

### SUMMARY

Typical wagering systems are either organized or informal. In informal wagering, individuals will routinely engage in binary wagers where the winner of the wager is determined based on the outcome of some event. For example, wagering on sporting events is common where one individual will wager that his favorite basketball team will beat the basketball team supported by another individual. The bet may be a simple “straight up” bet, which is determined by which team wins the basketball game. The bet also may be more complicated in that it involves giving “odds” or “spotting points.” An individual can give “odds” by offering to pay the other player a multiple of the amount of the wager. For example, if Player A is confident that the Boston Celtics will beat the Los Angeles Lakers, Player A can offer 2:1 odds to Player B such that for a $5 wager Player A would pay Player B $10 if the Lakers win, but Player B would only pay Player A $5 if the Celtics win. Alternately, Player A can “spot” Player B 10 points such that 10 points will be added to the final score of the Lakers to determine who wins the wager. In this way, Player B wins the wager even if the Lakers lose, so long as the loss is nine points or less.

Another type of informal wagering that is typical in the prior art involves “pools” of bets. For example, one such pool is known as an office pool, where multiple individuals who work in the same office pay a set wager to select the outcome of multiple sporting events, e.g., Sunday's NFL games. The individual with the best record of picking the winners is awarded the wager from all other players.

On the other hand, organized wagering is typically managed by a sports betting agency or a casino, colloquially referred to as “the house.” Organized wagering is available for a variety of events, including sporting, social and political events. In organized wagering, the house typically charges a service fee for accepting a wager prior to the commencement of the wagered event and increases the service fee after event commencement. In order to minimize its exposure, the house identifies a counterparty to the wager, who also pays a service fee. Organized wagering can also include giving “odds”, and typically can include “spotting points” which is referred to as “the line.”

The prior art wagering systems had many disadvantages. For example, typical organized wagering entities charge a service fee on the order of 10% prior to the commencement of an event, which is raised to 20% during the event. For example, typically an individual must wager $11 to win $10. In the event that the bet loses, the house keeps the $11. In the event that the bet wins, the individual only wins $10 along with their initial wager of $11. During a live game, this difference or “juice” in sports betting terminology is as high at 20%. These type of service fees make it practically impossible for bettors to make a profit over the long run.

Another significant downside to both informal and organized wagering systems is that the wagers have no liquidity for the life of the wager. For example, once a wager is made, there is no independent value attributed to the wager and no mechanism for selling or buying the wager. Because there is no liquidity for wagers, bettors sometimes reduce their risk on an outstanding wager by taking an additional wager on the other side of the original wager, sometimes referred to as “hedging your bet.” However, this strategy results in cutting potential gains associated with the original wager significantly.

Another significant disadvantage in prior art wagering on event outcomes is that the wager is “binary” in that that wager either wins or loses based on the outcome of the event. Thus, the winners and losers are determined solely on the outcome of the event. To the extent that there is a “tie” in the outcome, the wagered money is returned as if the wager had not taken place. Importantly, there is no opportunity to monetize the wager in a manner that is independent of the outcome of the event.

The present application is directed to solving these disadvantages of the prior art. The present application creates “non-binary” wagering where the value of the wager is not solely dependent upon the outcome of the event, but instead includes a value that is independent of the outcome of the event.

### BRIEF DESCRIPTION OF THE DRAWINGS

FIG. 1 is a simplified flow diagram of one embodiment of the present disclosure.

FIG. 2 is a simplified network architecture for one embodiment of the present disclosure

FIG. 3 is a simplified pictorial representation of one embodiment of a graphical user interface for use with one embodiment of the present disclosure.

### DETAILED DESCRIPTION

The present application's creation of a non-binary wager presents many advantages over the prior art. In addition to allow wagering on the outcome of an event, like the typical binary wager, the non-binary wager can also be traded on a secondary market throughout its lifespan. Thus, the owner of the wager can make a profit through the secondary market for the wager before the outcome of the event is determined. The secondary market creates a more efficient mechanism to match counterparties to a wager that takes into account circumstance that may affect the outcome of the event and thus may be more attractive than the typical binary wager. As a result, the house need not charge service charges in the range of 10%-20%, but instead can charge service fees in the 1%-5% range. For example, in the prior art, a single binary wager resulted in a single service fee to the house. On the other hand, with the present application, a single initial non-binary wager can result in an initial service fee, and a service fee to the house each time the non-binary wager is traded on the secondary market. The reduction in service fees makes it more likely that non-binary wagers will be more profitable for the wagerer than wagers of binary wagers.

Thus, the present system and method provides a new paradigm in determining interest in the outcome of an event. By creating a unit that is priced and redeemable based on the outcome of the event, a secondary market for trading the units can be established that allows owners of the units to trade them during the course of the event and prior to completion of the event which provides a revenue opportunity that is independent of the ultimate outcome of the event.

In operation, a non-binary wager can be considered, but not limited to shares, contracts, wagers, or bets in the outcome of an event. The shares or units can have a fixed redemption value at the conclusion of the event. At issuance, the shares will be launched with an initial price. The initial price can be arbitrarily set, but is generally a portion of the redemption value based on the likelihood of the desired outcome of the event. The likelihood of the desired outcome can be based on mathematical probability of the outcome, and may use game theory, artificial intelligence, machine learning, or the like. Once a user purchases a share, the share is able to be traded on a secondary platform before the conclusion of the event. Upon conclusion of the event, the shares are paid out by the house at their preset redemption value.

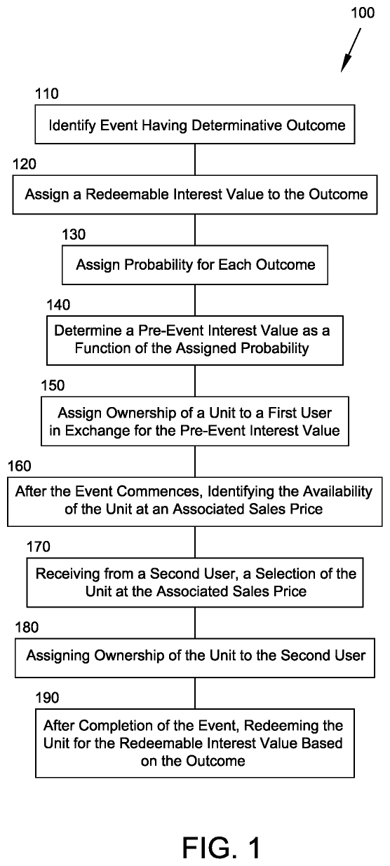

FIG. 1 illustrates one embodiment of a method of determining interests in the outcome of an event 100. Further the event can be any activity that has an outcome determinative completion such as a sporting competition, a political event, a naturally occurring event, or a man-made event. The event can be a single event or a plurality of events. For example, the event can be a single basketball game between two teams, or a playoff competition of sixteen teams including a plurality of games between the various teams.

In step 110, a processor can identify an event having more than one determinative outcome. For example, in a basketball game, either team can win the game, or the game can end in a tie. In another example, a team can win one game, or win multiple games. In another example, a team can win a game by more than a fixed number of points. In yet another example, a team can advance to subsequent rounds of a tournament. Thus, the processor can select which of the determinative outcomes can be identified for an event.

In step 120, a processor assigns a redeemable interest value of a unit based on each identified determinative outcome. For example, the processor may assign a redeemable interest value of a unit at $1 based on Team A winning a regular season game, a redeemable interest value of a unit at $5 based on Team A winning a first round playoff game or series, a redeemable interest value of a unit at $10 based on Team A wining a second round playoff game or series, and a redeemable interest value of a unit at $20 based on Team A winning a championship game or series. Thus, the redeemable interest value of a unit can be selectively assigned to determine how much a unit is worth if the determinative outcome occurs.

In step 130, a processor assigns a probability for each one of the identified determinative outcomes. The probability can be based on the likelihood of the determinative outcome occurring. In one embodiment, one source of information is a database of historical outcomes that can be used to assign a probability using data analytics. For example, historical data can be collected for each member of a sports team that reflects the performance of the player in various circumstances, including traditional statistics associated with the game as well as group statistics of various combinations of players that may be performing together, as well as individual and group statics for players on the competing team. Data analytics can be used to predict the outcome of a game between two teams, or even of various groups of players of the respective teams.

Another source of information that can be used to assign a probability is a betting line. In wagering systems, a betting line is based on the sentiment of betters regarding the probable outcome of an event. The betting line is typically determined based on the amount of wagers for each outcome of the event. For example, in a basketball game, as the amount of wagers that Team A will win the basketball game surpasses the amount of wagers that Team B will win the basketball game, a betting line may indicate that Team A needs to beat Team B by a set number of points in order for the wager on Team A to win. As more and more wagers are placed on Team A, the amount of points that Team A gives Team B increases, thus increasing the line to encourage more bettors to wager on Team B. Thus, the processor can assign a probability based on the betting line.

Another source of information that can be used is a third-party handicapper. Third-party handicapper can use a manual or automatic algorithm to predict outcomes of event. For example, they may be predict that team A will beat team B by 10 points. The processor can assign a probability based on the prediction of a third-party handicapper.

The processor may also assign weights to the various sources of data so that the assigned probability is a weighted average of plural sources.

In step 140, the processor determines a pre-event interest value for the unit as a function of each assigned probability before the event commences. The pre-event interest value for the unit is typically a portion of the redeemable interest value. For example, if the redeemable interest value for a unit that Team A wins a single regular season game is $1, and it is determined that Team A has a 60% probability of beating Team B, then the pre-event interest value for a unit of Team A winning the game can be set at $0.60 and the pre-event interest value for a unit of Team B winning the game can be set at $0.40.

In step 150, a processor can assign ownership of a unit to a first user in exchange for the determined pre-event interest value. In one embodiment, a processor can maintain a ledger that tracks the ownership of all units. The processor can make all available units for display on a graphical user interface so that a user is able to select the units to purchase at the determined pre-event interest value. The user then is charge the determined pre-event interest value for each of the selected units and the processor can assign ownership of the units in the ledger to the first user. The payment can be accomplished using conventional electronic payment technology, including the use of distributed ledgers to ensure the security of the transaction. In addition to the determined pre-event interest value, the user may be charged a service fee for the transaction.

In step 160, after the event has commenced, trading of units between assigned owners of the units is available. A processor receives a plurality of offers to buy and sell the unit after the event has commenced but before the event has completed. Pricing of the units after commencement of the event can follow free market principles of supply and demand and can take into account real-time activities associated with the event such as current score, player performance, player health, team standing, team performance of any other indicators that a user may find useful in predicting the outcome of the event.

In one embodiment, a processor can identify on a display the availability of a unit and an associated sales price for the unit. For example, a second user, User B can receive the display of available units and associated sale prices. In step 170, User B can select a unit at the offered purchase price. In step 180, the processor can assign ownership of the unit to the User B, and pay an appropriate amount of the purchase price to the User A, the original owner of the unit. Importantly, User A can thus receive revenue before the event is completed and thus a revenue stream has been created that is independent of the ultimate outcome of the event.

In one embodiment, the processor credits User A's account with only a portion of the purchase price and keeps remaining portion as a service charge. Thus, a new revenue stream has also been created for the “house” in the form of service fees from the secondary market of trading units.

In another embodiment, a processor can make available a display of units desired to be purchased and an associated offer price for the unit. For example, User B can offer to purchase a unit at desired purchase price and the processor can assign ownership of the unit to the User B, and pay an appropriate amount of the purchase price to the User A, the original owner of the unit. In one embodiment, the processor credits User A's account with only a portion of the purchase price and keeps remaining portion as a service charge.

In another embodiment, the processor can match an offer to sell the unit with an offer to buy the unit and charge both the buyer and the seller of the unit with a service charge.

As part of the secondary market in trading the units, the processor can maintain a ledger of the ownership of the units and can use distributed ledger technology to verify the transfer of ownership of the units.

In Step 190, at the completion of the event, the processor redeems the unit for the redeemable interest value and credits the account of the then current owner, User B, the redeemable interest value.

One embodiment of the present disclosure will be described in the context of a National Basketball Association game between the Boston Celtics and the Los Angeles Lakers. The house may set an initial number of units or shares to be sold for either the Celtics or the Lakers to win a scheduled basketball game. For example, 5000 shares may be available that can be redeemed for $1 if the Celtics win, and another 5000 shares may be available that can be redeemed for $1 if the Lakers win. Thus, the total redemption exposure to the house for the game is $5000, regardless of who wins. The house will set the initial pre-event value of the shares as a function of the probability that each team will win the game. For example, if the house determines that Boston has a 60% chance of winning the game, and Los Angeles has a 40% chance of winning the game, the share that Boston will win the game can be set at an initial price of $0.60 and the shares that Los Angeles will win the game can be set at an initial price of $0.40. In one embodiment, the house can charge a 2% transaction fee. Thus, User A would pay $0.612 in exchange for 1 share of Boston, and User B would pay $0.408 in exchange for 1 share of Los Angeles. After the initial sale of the shares, they can be traded on a platform that facilitates secondary trading for an additional service fee. For example, User A can sell one share of Boston on exchange to User C for $0.80, and User A pays a 2% service fee and therefore realizes $0.784 for the sale of the share. User C pays $0.80 for the share to User A, and a 2% service fee to the house. These transactions can be peer to peer or through the platform and sold back to the company. At the completion of a wager event, the shares of the winning team are redeemable, while the shares of the losing team have no redemption value. For example, if Boston wins the game, all Boston shares are redeemable at $1 per share, and the Los Angeles shares have no redemption value. The redemption can happen automatically or manually.

In one embodiment, the shares or units are not available for trading on the secondary market until all initial shares are sold and, thereafter, can be sold on the secondary market up to the competition of the wager event, including during the wager event. The initial pricing of the shares can be determined based on the potential outcomes and payouts. Thereafter, the shares will be traded freely from user to user, and thus, the pricing of a share during the lifespan of the option will be determined by the free market and user-to-user transactions. These transactions could be user to user or use a third-party intermediary.

The above example is a simplified single wager on the outcome of a single event. The present disclosure allows more complicated wagers based on the outcomes of multiple events and allows for variable redemption values. For example, a wager can be on a single team for the season, and thus the event is the performance of the team during the season. The table below shows the redemption value of a single share based on multiple event outcomes with continued reference to professional basketball games:

| | Redemption | Number of Event | Total Redemption |
|---|---|---|---|
| Event | Value | Occurrences | Liability to House |
| Each regular season | $1 | 1230 games (30 | 1230*$1 = $1230 |
| win | | Teams) | |
| Make the playoffs | $5 | 16 Teams | 16*$5 = $80 |
| Win 1^{st} round | $10 | 8 Teams | 8*$10 = $80 |
| Win 2^{nd} round | $15 | 4 Teams | 4 * $15 = $60 |
| Win Conference | $20 | 2 Teams | 2*$20 = $40 |
| Championship | | | |
| Win NBA Finals | $25 | 1 Team | 1*$25 = $25 |
| Cumulative Total | | | $1515 |

Based on the table above, the house can arbitrarily set the initial price for a share in each team based on the probability of success for each team for each event, where the ultimate outcome of the event is based on the individual outcomes of bundled events. For example, the house can set the initial price for a share of the Boston Celtics at $65 per share based on an expected 50 wins in the regular season, making the playoffs, and winning the first round. By way of further example, the house can set the initial price of the New York Knicks at $32 per share based on an expected 32 wins and not making the playoffs.

In one embodiment, the house can charge a 2% transaction fee. Thus, User A would pay $66.30 in exchange for one share of Boston, and User B would pay $32.64 in exchange for one share of the Knicks. After the initial sale of the shares, they can be traded on a platform that facilitates secondary trading for an additional service fee. For example, User A can sell one share of Boston on an exchange to User C for $80.00, and User A pays a 2% service fee and therefore realizes $78.40 for the sale of the share. User C pays $80.00 for the share to User A, and a 2% service fee to the house. These transactions may not be user to user, but use a matching algorithm through a third-party intermediary. At the completion of the season, the shares of each team are redeemed according to the outcome of the events. For example, if Boston wins 52 games and the first two rounds of the playoff, a share can be redeemed for $82 per share ($52 for regular season wins, $5 for making the playoffs, $10 for the 1st round win and $15 for the 2nd round win.) In similar fashion, if New York wins 25 games and misses the playoffs, a share in New York can be redeemed for $25. Based on the table above, the total redemption paid out by the house for all teams would be $1,515. The table above represents just one example, and the redemption value for each event is selectable by the house. This model is not limited to basketball, or even sports, but can be applied to other political, social, entertainment or events. The shares may have varying lengths, initial prices, payout structures, entities performing (different sports/topics/teams/individuals), and monetization/fees.

The shares can be issued, assigned and implemented using distributed ledger technologies, e.g., blockchain, or other types of decentralized technologies.

In other embodiments, dividend payments can be added throughout the lifespan of the share. In other embodiments, the shares may represent registered securities. In other embodiments, the shares may represent collectibles.

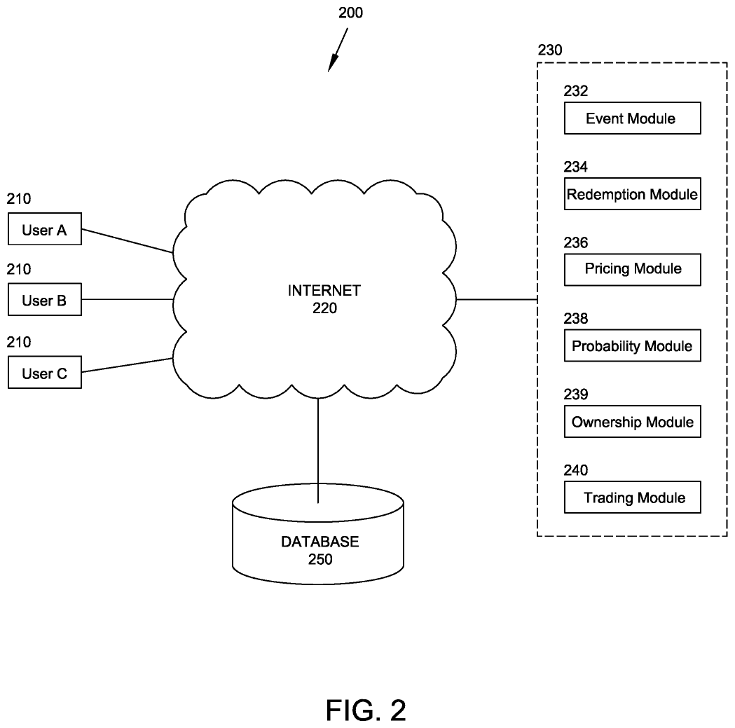

FIG. 2 is a simplified network architecture 200 for one embodiment of the present disclosure. Users 210 access the system through processor-enabled devices that allow conventional web browser functionality and graphical user interfaces to connect through the internet 220 to a processor 230, which implements the methods described herein. Software required to provide the required functionality of the devices can be in the form of a mobile application downloaded on the device. Processor 230 includes various modules including memory for storing computer readable code with instructions for a processor to perform. Event module 232 can access database 250 containing various types of events and can identify an event having more than one determinative outcome.

Redemption module 254 can assign a redeemable interest value of a unit based on each identified determinative outcome. At the completion of the event, the redemption module redeems the unit for the redeemable interest value and credits the account of the then current owner as determined by ownership module 239.

Probability module 236 can assign a probability for each one of the identified determinative outcomes. Probability module can also access database 250 that includes historical outcomes of events, betting lines, and a third-party handicapper data. T

Pricing module 238 can determine a pre-event interest value for the unit as a function of each assigned probability before the event commences.

Ownership module 239 can assign ownership of a unit to a first user in exchange for the determined pre-event interest value. Ownership module 239 can assign ownership of a unit to subsequent users during secondary trading of the unit.

Trading module 240 facilitates trading of units between assigned owners of the units. Pricing module 238 can price the units based on free market principles of supply and demand, and trading module can make this information available to users 210 through conventional graphical user interfaces.

In Step 190, at the completion of the event, the processor redeems the unit for the redeemable interest value and credits the account of the then current owner, User B, the redeemable interest value.

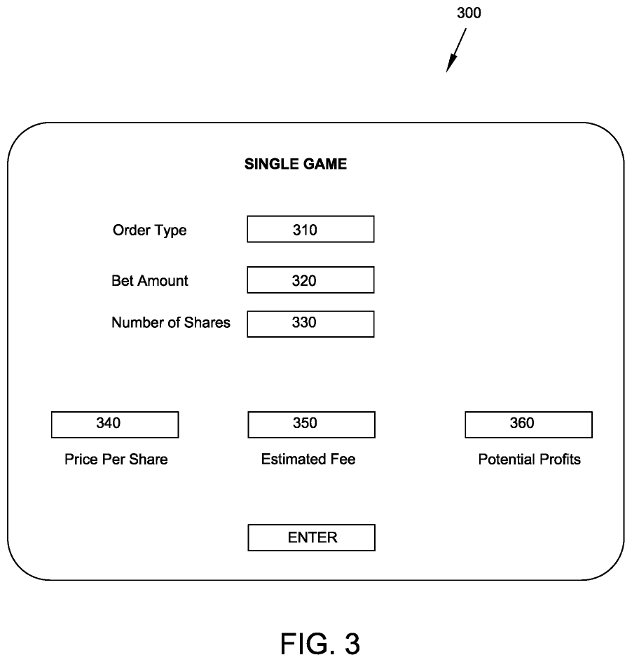

FIG. 3 illustrates a simplified pictorial representation of one embodiment of a graphical user interface 300 for use with one embodiment of the present disclosure. A user, such as shown in FIG. 2, is given the option of selecting an order type 310 such as buy, sell, limit order, stop order, etc. for a given event. A single game is illustrated in FIG. 3. The user can enter a bet amount 320 or the number of units 300. The interface 200 also provides the then current price per share 340, the estimated service fee 350, if any, and the potential profit 360 if the desired event outcome is achieved.

The present disclosure can be implemented by a general-purpose computer programmed in accordance with the principals discussed herein. It may be emphasized that the above-described embodiments, particularly any “preferred” embodiments, are merely possible examples of implementations, merely set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure and the present disclosure and protected by the following claims.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a computer readable medium. The computer readable medium can be a machine-readable storage device, a machine-readable storage substrate, a memory device, or a combination of one or more of them.

The term “processor” encompasses all apparatus, devices, and machines for processing data, including by way of example a programmable processor, a computer, or multiple processors or computers. The processor can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more data memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer readable media suitable for storing computer program instructions and data include all forms data memory including non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Those skilled in the art will appreciate that the present invention can be practiced by other than the described embodiments, which are presented for the purposes of illustration and not of limitation, and the present invention is limited only by the claims which follow.

What is claimed is:

1. A method of determining interests in the outcome of an event, the steps comprising:
a. using a processor, identifying an event having more than one determinative outcome;
b. using a processor, determining a redeemable interest value of a unit based on each identified determinative outcome;
c. using a processor, assigning a probability for each one of the identified determinative outcomes;
d. using a processor, determining a pre-event interest value for the unit as a function of each assigned probability before the event commences;
e. using a processor, assigning ownership of a unit to a first user in exchange for the determined pre-event interest value;
f. after the event commences, using a processor, identifying the availability of the unit at an associated sales price;
g. using a processor, receiving from a second user a selection of the unit at the associated sales price;
h. using a processor, assigning ownership of the unit to the second user in exchange for the associated sales price; and
i. after completion of the event, using a processor, redeeming the unit for the redeemable interest value based on the outcome of the event.

2. The method claim 1 wherein the event is a single game in a sport.

3. The method of claim 1 wherein the event is a plurality of games in a single sport.

4. The method of claim 1 wherein the event is a plurality of games in a plurality of sports.

5. The method of claim 2 wherein the assigned probability is the likelihood of a team winning the game.

6. The method of claim 3 wherein the assigned probability is the likelihood of a team winning each of the plurality of games.

7. The method of claim 1 wherein the pre-event interest value for the unit is a portion of the redeemable interest value.

8. The method of claim 1, wherein the step of assigning ownership of the unit to the second user in exchange for the associated sales price occurs independent of the outcome of the event.

9. A system for determining interests in the outcome of an event, comprising:
a memory for storing computer readable code;
a processor operatively coupled to the memory, the processor configured to:
identify an event having more than one determinative outcome;
determine a redeemable interest value of a unit based on each identified determinative outcome;
assign a probability for each one of the identified determinative outcomes;
determine a pre-event interest value for the unit as a function of each assigned probability before the event commences;
assign ownership of a unit to a first user in exchange for the determined pre-event interest value;
after the event commences, identify the availability of the unit at an associated sales price;
receive from a second user a selection of the unit at the associated sales price;
assign ownership of the unit to the second user in exchange for the associated sales price; and
after completion of the event, redeem the unit for the redeemable interest value based on the outcome of the event.

10. The system of claim 9 wherein the event is a single game in a sport.

11. The system of claim 9 wherein the event is a plurality of games in a single sport.

12. The system of claim 9 wherein the event is a plurality of games in a plurality of sports.

13. The system of claim 10 wherein the assigned probability is the likelihood of a team winning the game.

14. The system of claim 11 wherein the assigned probability is the likelihood of a team winning each of the plurality of games.

15. The system of claim 9 wherein the pre-event interest value for the unit is a portion of the redeemable interest value.

16. The system of claim 9, assigning ownership of the unit to the second user in exchange for the associated sales price occurs independent of the outcome of the event.
